(19) United States
(12) Patent Application Publication
(10) Pub. No.: US 2010/0152354 A1
(43) Pub. Date: Jun. 17, 2010

(54) ALUMINUM HYDROXIDE PARTICLES PRODUCED FROM AN ORGANIC ACID CONTAINING ALUMINUM HYDROXIDE SLURRY

(75) Inventors: Rene Gabriel Erich Herbiet, Eupen (BE); Winfried Toedt, Steffeln-Auel (DE)

Correspondence Address: ALBEMARLE CORPORATION;PATENT DEPARTMENT, 451 FLORIDA STREET, BATON ROUGE, LA, 70801, US

(73) Assignee: MARTINSWERK GMBH, Bergheim (DE)

(21) Appl. No.: 12/304,527

(22) PCT Filed: Jun. 21, 2007
(86) PCT No.: PCT/IB2007/004572

§ 371 Date: Dec. 12, 2008

Related U.S. Application Data
(60) Provisional application No. 60/815,426, filed on Jun. 21, 2006.
(60) Provisional application No. 60/815,515, filed on Jun. 21, 2006.
(60) Provisional application No. 60/818,632, filed on Jul. 5, 2006.
(60) Provisional application No. 60/818,633, filed on Jul. 5, 2006.
(60) Provisional application No. 60/818,670, filed on Jul. 5, 2006.
(60) Provisional application No. 60/828,912, filed on Oct. 10, 2006.
(60) Provisional application No. 60/828,877, filed on Oct. 10, 2006.
(60) Provisional application No. 60/828,901, filed on Oct. 10, 2006.
(60) Provisional application No. 60/828,908, filed on Oct. 10, 2006.
(60) Provisional application No. 60/889,316, filed on Feb. 12, 2007.
(60) Provisional application No. 60/889,330, filed on Feb. 12, 2007.
(60) Provisional application No. 60/889,319, filed on Feb. 12, 2007.
(60) Provisional application No. 60/889,325, filed on Feb. 12, 2007.
(60) Provisional application No. 60/889,320, filed on Feb. 12, 2007.
(60) Provisional application No. 60/889,316, filed on Feb. 12, 2007.
(60) Provisional application No. 60/889,327, filed on Feb. 12, 2007.
(60) Provisional application No. 60/891,746, filed on Feb. 27, 2007.
(60) Provisional application No. 60/891,747, filed on Feb. 27, 2007.
(60) Provisional application No. 60/891,745, filed on Feb. 27, 2007.
(60) Provisional application No. 60/891,748, filed on Feb. 27, 2007.
(60) Provisional application No. 60/916,477, filed on May 7, 2007.

(51) Int. Cl. C08K 3/22; C01F 7/04

(52) U.S. Cl. 524/437; 423/626

(57) ABSTRACT

The present invention relates to a process for producing aluminum hydroxide flame retardants from an organic acid containing aluminum hydroxide slurry.

### FIELD OF THE INVENTION

The present invention relates to a process for the production of aluminum hydroxide flame retardants. More particularly, the present invention relates to a process for producing aluminum hydroxide flame retardants from an organic acid containing aluminum hydroxide slurry.

### BACKGROUND OF THE INVENTION

Aluminum hydroxide has a variety of alternative names such as aluminum hydrate, aluminum trihydrate etc., but is commonly referred to as ATH. ATH particles find use as a filler in many materials such as, for example, plastics, rubber, thermosets, papers, etc. These products find use in diverse commercial applications such as wire and cable compounds, conveyor belts, thermoplastics moldings, wall claddings, floorings, etc. ATH is typically used to improve the flame retardancy of such materials and also acts as a smoke suppressant.

Methods for the synthesis of ATH are well known in the art. However, the demand for tailor made ATH grades is increasing, and the current processes are not capable of producing these grades. Thus, there is an increasing demand for superior methods of production for ATH.

### BRIEF DESCRIPTION OF THE FIGURES

FIG. 1 is a graph depicting the cumulative pore volume as a function of the pore size of an ATH produced according to the present invention, in comparison with standard grades.

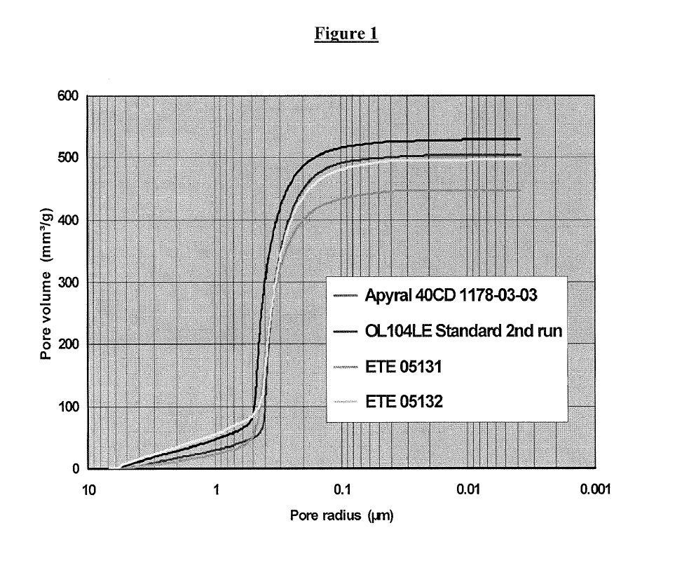

FIG. 2 is a graph depicting the pore volume of an ATH produced according to the present invention, in comparison with standard grades.

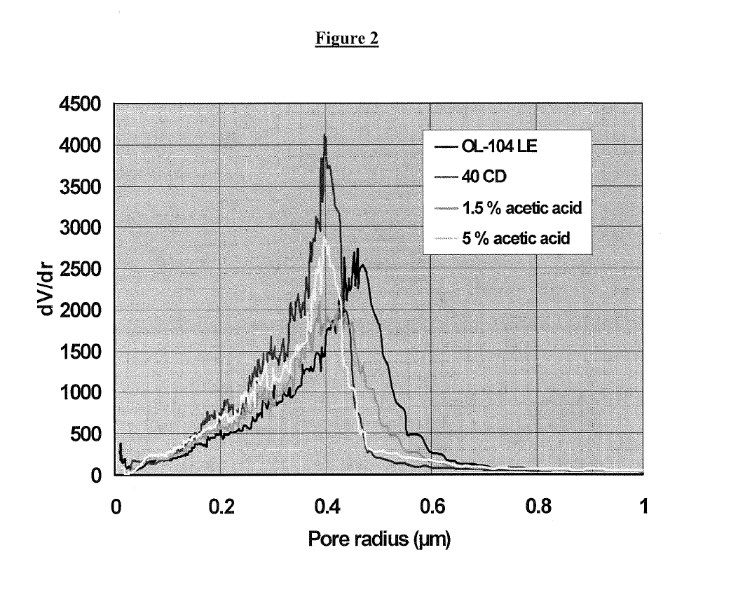

### SUMMARY OF THE INVENTION

Higher compounding throughputs can be achieved through the use of ATH's with better wettability in a selected synthetic material (resin). An ATH with a poor wettability in the synthetic resin leads to higher variations in the power draw of the compounder motor during compounding, which in turn leads to, at best, a moderate compound quality, low throughputs, and, over time, can represent a considerable risk for damage to the engine of the compounding machine.

The inventors have discovered that the addition of an organic acid to a filter cake or to a slurry that is subsequently dried produces ATH products having improved wettablility in synthetic resins. While not wishing to be bound by theory, the inventors hereof believe that this improved wettability is attributable to an improvement in the morphology of the ATH particles produced by the process described herein.

Thus, in one embodiment, the present invention relates to a process that can produce ATH's with improved wettability. In this embodiment, the present invention comprises:

adding to a filter cake containing in the range of from about 1 to about 80 wt. % ATH, based on the total weight of the filter cake, in the range of from about 0.1 to about 10 wt. %, based on the total weight of the ATH in the filter cake, of one or more organic acids, and optionally i) one or more dispersing agents; ii) water; or combinations of i) and ii) thus producing an acid-containing ATH slurry, and

drying said acid-containing ATH slurry thus producing ATH product particles.

### DETAILED DESCRIPTION OF THE INVENTION

As stated above, the inventors hereof have unexpectedly discovered that by using the process of the present invention, ATH particles having an improved wettability in relation to ATH particles currently available can be produced. In the practice of the present invention, one or more organic acids or one or more acids and one or more dispersing agents are added to an ATH-containing filter cake, and the acid-containing ATH slurry is subsequently spray dried.

### Filer Cake

The amount of ATH particles present in the filter cake to which the one or more organic acids or one or more acids and one or more dispersing agents is added can be obtained from any process used to produce ATH particles. Preferably the filter cake is obtained from a process that involves producing ATH particles through precipitation and filtration. In an exemplary embodiment, the filter cake is obtained from a process that comprises dissolving crude aluminum hydroxide in caustic soda to form a sodium aluminate liquor, which is cooled and filtered thus forming a sodium aluminate liquor useful in this exemplary embodiment. The sodium aluminate liquor thus produced typically has a molar ratio of Na₂O to Al₂O₃ in the range of from about 1.4:1 to about 1.55:1. In order to precipitate ATH particles from the sodium aluminate liquor, ATH seed particles are added to the sodium aluminate liquor in an amount in the range of from about 1 g of ATH seed particles per liter of sodium aluminate liquor to about 3 g of ATH seed particles per liter of sodium aluminate liquor thus forming a process mixture. The ATH seed particles are added to the sodium aluminate liquor when the sodium aluminate liquor is at a liquor temperature of from about 45 to about 80° C. After the addition of the ATH seed particles, the process mixture is stirred for about 100 h or alternatively until the molar ratio of Na₂O to Al₂O₃ is in the range of from about 2.2:1 to about 3.5:1, thus forming an ATH suspension. The obtained ATH suspension typically comprises from about 80 to about 160 g/l ATH, based on the suspension. However, the ATH concentration can be varied to fall within the ranges described above. The obtained ATH suspension is then filtered and washed to remove impurities therefrom, thus forming a filter cake. In one embodiment, the one or more organic acids or one or more acids and one or more dispersing agents are added to the filter cake to obtain a slurry. In these embodiments, the slurry generally contains in the range of from about 1 to about 80 wt. %, based on the total weight of the slurry, preferably in the range of from about 20 to about 65 wt. %, more preferably in the range of from about 30 to about 60 wt.-%, most preferably in the range of from about 35 to about 50 wt. %, all on the same basis. In another embodiment of the present invention, the filter cake is re-slurried with water to form a slurry to which the one or more organic acids are added. In these embodiments, the slurry generally contains in the range of from about 1 to about 40 wt. %, based on the total weight of the slurry, preferably in the range of from about 5 to about 40 wt. %, more preferably in the range of from about 10 to about 35 wt.-%, most preferably in the range of from about 20 to about 30 wt. %, all on the same basis.

However, in some embodiments, a dispersing agent is added to the filter cake to form the slurry to which the one or more organic acids are added. Non-limiting examples of dispersing agents include polyacrylates, organic acids, naphtalensulfonate/formaldehyde condensate, fatty-alcohol-polyglycol-ether, polypropylene-ethylenoxid, polyglycol-ester, polyamine-ethylenoxid, phosphate, polyvinylalcohole. If the slurry comprises a dispersing agent, the slurry may contain up to about 80 wt. % ATH, based on the total weight of the slurry, because of the effects of the dispersing agent. Thus, in this embodiment, the slurry typically comprises in the range of from 1 to about 80 wt. % ATH, based on the total weight of the slurry, preferably the slurry comprises in the range of from about 40 to about 75 wt. %, more preferably in the range of from about 45 to about 70 wt. %, most preferably in the range of from about 50 to about 65 wt. %, ATH, based on the total weight of the slurry.

It should be noted that before the filter cake is re-slurried, whether it be through the use of water, an acid, a dispersing agent or any combination thereof, the filter cake can be, and in embodiments is, washed one, or in some embodiments more than one, times with water, preferably de-salted water, before re-slurrying.

The ATH particles in the filter cake and subsequently formed slurry are generally characterized as having a BET in the range of from about 0.5 to 8 m²/g. In preferred embodiments, the ATH particles in the filter cake and subsequently formed slurry have a BET in the range of from about 1.5 to about 5 m²/g, more preferably in the range of from about 2.0 to about 3.5 m²/g

The ATH particles in the filter cake and subsequently formed slurry can be further characterized as having a d₅₀ in the range of from about 1.0 to 6.0 μm. In preferred embodiments, the ATH particles in the filter cake and subsequently formed slurry have a d₅₀ in the range of from about 1.5 to about 3.5 μm, more preferably in the range of from about 2.0 to about 3.0 μm.

### Addition of Organic Acid

The inventors hereof have unexpectedly discovered that the addition of in the range of from about 0.1 to about 10 wt. %, based on the total weight of the ATH in the slurry or the filter cake, of one or more organic acids to an ATH containing filter cake or slurry prior to drying allows for the production of ATH product particles having smaller, on average, pores, as determined by the median pore radius, discussed below, of the pores and/or a lower total specific pore volume, also as described below. In some embodiments in the range of from about 0.5 to about 10 wt. %, in some embodiments in the range of from about 1 to about 8 wt. %, in some embodiments in the range of from about 1 to about 6 wt. %, all based on the total weight of the ATH particles in the filter cake or in the slurry, of one or more organic acids is added to the ATH-containing filter cake or slurry described above. In some embodiments in the range of from about 0.5 to about 3 wt. %, on the same basis, of the one or more organic acids is used, and in still other embodiments in the range of from about 3 to about 6 wt. %, on the same basis, of the one or more organic acids is used. In some embodiments, only one organic acid is used, in other embodiments more than one organic acid is used.

The one or more organic acids can be added to the filter cake or the slurry at any point before drying. In some embodiments, the one or more organic acids are added under mechanical agitation.

Non-limiting examples of suitable organic acids include fumic, acetic, citric, and the like. In some embodiments, the organic acid used is acetic acid.

### Drying

After the addition of the one or more organic acids, the organic acid containing ATH slurry is dried to produce ATH product particles, as described below. The organic acid containing ATH slurry can be dried by any suitable technique known to be effective at producing ATH particles from an ATH slurry. Non-limiting examples of suitable drying techniques include belt filter drying, spray drying, mill-drying, and the like. In some embodiments, the organic acid containing ATH slurry is dried via spray drying, in other embodiments via belt drying, in still other embodiments via mill-drying.

Spray drying is a technique that is commonly used in the production of aluminum hydroxide. This technique generally involves the atomization of an ATH feed, here the organic acid containing ATH slurry, through the use of nozzles and/or rotary atomizers. The atomized feed is then contacted with a hot gas, typically air, and the spray dried ATH is then recovered from the hot gas stream. The contacting of the atomized feed can be conducted in either a counter or co-current fashion, and the gas temperature, atomization, contacting, and flow rates of the gas and/or atomized feed can be controlled to produce ATH particles having desired product properties.

The recovery of the ATH product particles can be achieved through the use of recovery techniques such as filtration or just allowing the “spray-dried” particles to fall to collect in the spray drier where they can be removed, but any suitable recovery technique can be used. In preferred embodiments, the ATH is recovered from the spray drier by allowing it to settle, and screw conveyors recover it from the spray-drier and subsequently convey through pipes into a silo by means of compressed air.

The spray-drying conditions are conventional and are readily selected by one having ordinary skill in the art with knowledge of the desired ATH particle product qualities, described below. Generally, these conditions include inlet air temperatures between typically 250 and 550° C. and outlet air temperatures typically between 105 and 150° C.

“Mill-drying” and “mill-dried” as used herein, is meant that the organic acid containing slurry is dried in a turbulent hot air-stream in a mill drying unit. The mill drying unit comprises a rotor that is firmly mounted on a solid shaft that rotates at a high circumferential speed. The rotational movement in connection with a high air through-put converts the through-flowing hot air into extremely fast air vortices which take up the organic acid containing slurry, accelerate it, and distribute and dry the organic acid containing slurry. After having been dried completely, the ATH particles are transported via the turbulent air out of the mill and separated from the hot air and vapors by using conventional filter systems. In another embodiment of the present invention, after having been dried completely, the ATH particles are transported via the turbulent air through an air classifier which is integrated into the mill, and are then transported via the turbulent air out of the mill and separated from the hot air and vapors by using conventional filter systems.

The throughput of the hot air used to dry the organic acid containing slurry is typically greater than about 3,000 Bm³/h, preferably greater than about to about 5,000 Bm³/h, more preferably from about 3,000 Bm³/h to about 40,000 Bm³/h, and most preferably from about 5,000 Bm³/h to about 30,000 Bm³/h.

In order to achieve throughputs this high, the rotor of the mill drying unit typically has a circumferential speed of greater than about 40 m/sec, preferably greater than about 60 m/sec, more preferably greater than 70 m/sec, and most preferably in a range of about 70 m/sec to about 140 m/sec. The high rotational speed of the motor and high throughput of hot air results in the hot air stream having a Reynolds number greater than about 3,000.

The temperature of the hot air stream used to mill dry the slurry or filter cake is generally greater than about 150° C., preferably greater than about 270° C. In a more preferred embodiment, the temperature of the hot air stream is in the range of from about 150° C. to about 550° C., most preferably in the range of from about 270° C. to about 500° C.

### Improved Morphology ATH

In general, the process of the present invention can be used to produce ATH product particles having many different properties. Generally, the process can be used to produce ATH product particles having an oil absorption, as determined by ISO 787-5:1980 of in the range of from about 1 to about 35%, a BET specific surface area, as determined by DIN-66132, in the range of from about 1 to 15 m²/g, and a d₅₀ in the range of from about 0.5 to 2.5.

However, the process of the present invention is especially well-suited to produce ATH product particles having an improved morphology when compared with currently available ATH. While not wishing to be bound by theory, the inventors hereof believe that this improved morphology is attributable to the total specific pore volume and/or the median pore radius (“r₅₀”) of the ATH product particles. The inventors hereof believe that, for a given polymer molecule, an ATH product having a higher structured aggregate contains more and bigger pores and seems to be more difficult to wet, leading to difficulties (higher variations of the power draw on the motor) during compounding in kneaders like Buss Ko-kneaders or twin-screw extruders or other machines known in the art and used to this purpose. Therefore, the inventors hereof have discovered that the process of the present invention produces ATH product particles characterized by smaller median pore sizes and/or lower total pore volumes, which correlates with an improved wetting with polymeric materials and thus results in improved compounding behavior, i.e. less variations of the power draw of the engines (motors) of compounding machines used to compound a flame retarded resin containing the ATH filler.

The r₅₀ and the specific pore volume at about 1000 bar (“Vₘₐₓ”) of the ATH product particles can be derived from mercury porosimetry. The theory of mercury porosimetry is based on the physical principle that a non-reactive, non-wetting liquid will not penetrate pores until sufficient pressure is applied to force its entrance. Thus, the higher the pressure necessary for the liquid to enter the pores, the smaller the pore size. A smaller pore size and/or a lower total specific pore volume were found to correlate to better wettability of the ATH product particles. The pore size of the ATH product particles can be calculated from data derived from mercury porosimetry using a Porosimeter 2000 from Carlo Erba Strumentazione, Italy. According to the manual of the Porosimeter 2000, the following equation is used to calculate the pore radius r from the measured pressure p: r=−2γ cos(θ)/p; wherein θ is the wetting angle and γ is the surface tension. The measurements taken herein used θ value of 141.3° for θ and γ was set to 480 dyn/cm.

In order to improve the repeatability of the measurements, the pore size of the ATH product particles was calculated from the second ATH intrusion test run, as described in the manual of the Porosimeter 2000. The second test run was used because the inventors observed that an amount of mercury having the volume V₀ remains in the sample of the ATH product particles after extrusion, i.e. after release of the pressure to ambient pressure. Thus, the r₅₀ can be derived from this data as explained below.

In the first test run, a sample of ATH product particles was prepared as described in the manual of the Porosimeter 2000, and the pore volume was measured as a function of the applied intrusion pressure p using a maximum pressure of 1000 bar. The pressure was released and allowed to reach ambient pressure upon completion of the first test run. A second intrusion test run (according to the manual of the Porosimeter 2000) utilizing the same ATH product particle sample, unadulterated, from the first test run was performed, where the measurement of the specific pore volume V(p) of the second test run takes the volume Vₒ as a new starting volume, which is then set to zero for the second test run.

In the second intrusion test run, the measurement of the specific pore volume V(p) of the sample was again performed as a function of the applied intrusion pressure using a maximum pressure of 1000 bar. The pore volume at about 1000 bar, i.e. the maximum pressure used in the measurement, is referred to as Vₘₐₓ herein.

From the second ATH product particle intrusion test run, the pore radius r was calculated by the Porosimeter 2000 according to the formula r=−2γ cos(θ)/p; wherein θ is the wetting angle, γ is the surface tension and p the intrusion pressure. For all r-measurements taken herein, a value of 141.3° for θ was used and γ was set to 480 dyn/cm. If desired, the specific pore volume can be plotted against the pore radius r for a graphical depiction of the results generated. The pore radius at 50% of the relative specific pore volume, by definition, is called median pore radius r₅₀ herein.

For a graphical representation of r₅₀ and Vₘₐₓ, please see U.S. Provisional Patent Applications 60/818,632; 60/818,633; 60/818,670; 60/815,515; and 60/818,426, which are all incorporated herein in their entirety.

The procedure described above was repeated using samples of ATH product particles produced according to the present invention, and the ATH product particles produced by the present invention were found to have an r₅₀, i.e. a pore radius at 50% of the relative specific pore volume, in the range of from about 0.09 to about 0.33 μm. In preferred embodiments of the present invention, the r₅₀ of the ATH product particles produced by the present invention is in the range of from about 0.20 to about 0.33 μm, more preferably in the range of from about 0.2 to about 0.3 μm. In other preferred embodiments, the r₅₀ is in the range of from about 0.185 to about 0.325 μm, more preferably in the range of from about 0.185 to about 0.25 μm. In still other preferred embodiments, the r₅₀ is in the range of from about 0.09 to about 0.21 μm, more preferably in the range of from about 0.09 to about 0.165 μm.

The ATH product particles produced by the present invention can also be characterized as having a Vₘₐₓ, i.e. maximum specific pore volume at about 1000 bar, in the range of from about 300 to about 700 mm³/g. In preferred embodiments of the present invention, the Vₘₐₓ, of the ATH product particles produced by the present invention is in the range of from about 390 to about 480 mm³/g, more preferably in the range of from about 410 to about 450 mm³/g. In other preferred embodiments, the Vₘₐₓ is in the range of from about 400 to about 600 mm³/g, more preferably in the range of from about 450 to about 550 mm³/g. In yet other preferred embodiments, the Vₘₐₓ, is in the range of from about 300 to about 700 mm³/g, more preferably in the range of from about 350 to about 550 mm³/g.

The ATH product particles produced by the present invention can also be characterized as having an oil absorption, as determined by ISO 787-5:1980 of in the range of from about 1 to about 35%. In some preferred embodiments, the ATH product particles produced by the present invention are characterized as having an oil absorption in the range of from about 23 to about 30%, more preferably in the range of from about 25% to about 28%. In other preferred embodiments, the ATH product particles produced by the present invention are characterized as having an oil absorption in the range of from about 25% to about 32%, more preferably in the range of from about 26% to about 30%. In yet other preferred embodiments, the ATH product particles produced by the present invention are characterized as having an oil absorption in the range of from about 25 to about 35% more preferably in the range of from about 27% to about 32%. In other embodiments, the oil absorption of the ATH product particles produced by the present invention are in the range of from about 19% to about 23%, and in still other embodiments, the oil absorption of the ATH product particles produced by the present invention is in the range of from about 21% to about 25%.

The ATH product particles produced by the present invention can also be characterized as having a BET specific surface area, as determined by DIN-66132, in the range of from about 1 to 15 m²/g. In preferred embodiments, the ATH product particles produced by the present invention have a BET specific surface in the range of from about 3 to about 6 m²/g, more preferably in the range of from about 3.5 to about 5.5 m²/g. In other preferred embodiments, the ATH product particles produced by the present invention have a BET specific surface of in the range of from about 6 to about 9 m²/g, more preferably in the range of from about 6.5 to about 8.5 m²/g. In still other preferred embodiments, the ATH product particles produced by the present invention have a BET specific surface in the range of from about 9 to about 15 m²/g, more preferably in the range of from about 10.5 to about 12.5 m²/g.

The ATH product particles produced by the present invention can also be characterized as having a dₛₒ in the range of from about 0.5 to 2.5 μm. In preferred embodiments, the ATH product particles produced by the present invention have a d₅₀ in the range of from about 1.5 to about 2.5 μm, more preferably in the range of from about 1.8 to about 2.2 μm. In other preferred embodiments, the ATH product particles produced by the present invention have a d₅₀ in the range of from about 1.3 to about 2.0 μm, more preferably in the range of from about 1.4 to about 1.8 μm. In still other preferred embodiments, the ATH product particles produced by the present invention have a d₅₀ in the range of from about 0.9 to about 1.8 μm, more preferably in the range of from about 1.1 to about 1.5 μm.

It should be noted that all particle diameter measurements, i.e. d₅₀, disclosed herein were measured by laser diffraction using a Cilas 1064 L laser spectrometer from Quantachrome. Generally, the procedure used herein to measure the d₅₀, can be practiced by first introducing a suitable water-dispersant solution (preparation see below) into the sample-preparation vessel of the apparatus. The standard measurement called “Particle Expert” is then selected, the measurement model “Range 1” is also selected, and apparatus-internal parameters, which apply to the expected particle size distribution, are then chosen. It should be noted that during the measurements the sample is typically exposed to ultrasound for about 60 seconds during the dispersion and during the measurement. After a background measurement has taken place, from about 75 to about 100 mg of the sample to be analyzed is placed in the sample vessel with the water/dispersant solution and the measurement started. The water/dispersant solution can be prepared by first preparing a concentrate from 500 g Calgon, available from KMF Laborchemie, with 3 liters of CAL Polysalt, available from BASF. This solution is made up to 10 liters with deionized water. 100 ml of this original 10 liters is taken and in turn diluted further to 10 liters with deionized water, and this final solution is used as the water-dispersant solution described above.

### Use as a Flame Retardant

The ATH product particles produced according to the present invention can be used as a flame retardant in a variety of synthetic resins. Non-limiting examples of thermoplastic resins where the ATH product particles find use include polyethylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, vinyl chloride-propylene copolymer, vinyl acetate resin, phenoxy resin, and the like. Further examples of suitable synthetic resins include thermosetting resins such as epoxy resin, phenol resin, melamine resin, unsaturated polyester resin, alkyd resin and urea resin and natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included. Further included are polymeric suspensions (latices).

Preferably, the synthetic resin is a polyethylene-based resins such as high-density polyethylene, low-density polyethylene, linear low-density polyethylene, ultra low-density polyethylene, EVA (ethylene-vinyl acetate resin), EEA (ethylene-ethyl acrylate resin), EMA (ethylene-methyl acrylate copolymer resin), EAA (ethylene-acrylic acid copolymer resin) and ultra high molecular weight polyethylene; and polymers and copolymers of C₂ to C₈ olefins (α-olefin) such as polybutene and poly(4-methylpentene-1), polyvinyl chloride and rubbers. In a more preferred embodiment, the synthetic resin is a polyethylene-based resin.

The inventors have discovered that by using the ATH particles produced according to the present invention as flame retardants in synthetic resins, better compounding performance, of the ATH-containing synthetic resin can be achieved. The better compounding performance is highly desired by those compounders, manufactures, etc. producing highly filled flame retarded compounds and final extruded or molded articles out of ATH-containing synthetic resins. By highly filled, it is meant those containing the flame retarding amount of ATH, discussed below.

By better compounding performance, it is meant that variations in the amplitude of the energy level of compounding machines like Buss Ko-kneaders or twin screw extruders needed to mix a synthetic resin containing ATH product particles according to the present invention are smaller than those of compounding machines mixing a synthetic resin containing conventional ATH product particles. The smaller variations in the energy level allows for higher throughputs of the ATH-containing synthetic resins to be mixed or extruded and/or a more uniform (homogenous) material.

Thus, in one embodiment, the present invention relates to a flame retarded polymer formulation comprising at least one synthetic resin, selected from those described above, in some embodiments only one, and a flame retarding amount of ATH product particles produced according to the present invention, and extruded and/or molded article made from the flame retarded polymer formulation.

By a flame retarding amount of the ATH product particles produced according to the present invention, it is generally meant in the range of from about 5 wt % to about 90 wt %, based on the weight of the flame retarded polymer formulation, and more preferably from about 20 wt % to about 70 wt %, on the same basis. In a most preferred embodiment, a flame retarding amount is from about 30 wt % to about 65 wt % of the ATH particles, on the same basis.

The flame retarded polymer formulations of the present invention can also contain other additives commonly used in the art. Non-limiting examples of other additives that are suitable for use in the flame retarded polymer formulations of the present invention include extrusion aids such as polyethylene waxes, Si-based extrusion aids, fatty acids; coupling agents such as amino-, vinyl- or alkyl silanes or maleic acid grafted polymers; sodium stearate or calcium sterate; organoperoxides; dyes; pigments; fillers; blowing agents; deodorants; thermal stabilizers; antioxidants; antistatic agents; reinforcing agents; metal scavengers or deactivators; impact modifiers; processing aids; mold release aids, lubricants; anti-blocking agents; other flame retardants; UV stabilizers; plasticizers; flow aids; and the like. If desired, nucleating agents such as calcium silicate or indigo can be included in the flame retarded polymer formulations also. The proportions of the other optional additives are conventional and can be varied to suit the needs of any given situation.

The methods of incorporation and addition of the components of the flame-retarded polymer formulation is not critical to the present invention and can be any known in the art so long as the method selected involves substantially uniform mixing of the components. For example, each of the above components, and optional additives if used, can be mixed using a Buss Ko-kneader, internal mixers, Farrel continuous mixers or twin screw extruders or in some cases also single screw extruders or two roll mills. The flame retarded polymer formulation can then be molded in a subsequent processing step, if so desired. In some embodiments, apparatuses can be used that thoroughly mix the components to form the flame retarded polymer formulation and also mold an article out of the flame retarded polymer formulation. Further, the molded article of the flame-retardant polymer formulation may be used after fabrication for applications such as stretch processing, emboss processing, coating, printing, plating, perforation or cutting. The molded article may also be affixed to a material other than the flame-retardant polymer formulation of the present invention, such as a plasterboard, wood, a block board, a metal material or stone. However, the kneaded mixture can also be inflation-molded, injection-molded, extrusion-molded, blow-molded, press-molded, rotation-molded or calender-molded.

In the case of an extruded article, any extrusion technique known to be effective with the synthetic resins mixture described above can be used. In one exemplary technique, the synthetic resin, aluminum hydroxide particles, and optional components, if chosen, are compounded in a compounding machine to form a flame-retardant resin formulation as described above. The flame-retardant resin formulation is then heated to a molten state in an extruder, and the molten flame-retardant resin formulation is then extruded through a selected die to form an extruded article or to coat for example a metal wire or a glass fiber used for data transmission.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, a flame retarding amount of the ATH, can also include amounts in the range of about 70 to about 90 wt. %, 20 to about 65 wt. %, etc.

The following examples will illustrate the present invention, but are not meant to be limiting in any manner.

### EXAMPLES

The r₅₀ and Vₘₐₓ described in the examples below was derived from mercury porosimetry using a Porosimeter 2000, as described above. All d₅₀, BET, oil absorption, etc., unless otherwise indicated, were measured according to the techniques described above. Also, the term “inventive aluminum hydroxide grade” and “inventive filler” as used in the examples is meant to refer to an ATH produced according to the present invention, and “comparative aluminum hydroxide grade” is meant to refer to an ATH that is commercially available and not produced according to the present invention.

### Example 1

### Comparative

A filter cake with an ATH solid content of 56 wt. % was prepared by precipitation and filtration. The ATH particles in the filter cake had a median particle size d₅₀ of 1.87 μm and a specific BET surface of 3.4 m²/g. A sufficient amount of water was added to the filter cake to obtain a slurry with a solid content of 33 wt. %. A pilot spray drier from the Niro company, type “Minor Production”, was used to spray dry the slurry. The throughput of the spray drier was approx. 12 kg/h solids, the inlet air temperature was about 400° C., and the outlet air temperature was about 130° C. The median pore radius (“r₅₀”) and the maximum specific pore volume (“Vₘₐₓ”) of the dried aluminum hydroxide particles were derived from mercury porosimetry, and are reported in Table 1, below.

### Example 2

### According to the Invention

A filter cake with an ATH solid content of 56 wt. % was prepared by precipitation and filtration. The ATH particles in the filter cake had a median particle size d₅₀ of 1.87 μm and a specific BET surface of 3.4 m²/g. A sufficient amount of water was added to the filter cake to obtain a slurry with a solid content of 33 wt. %. A quantity of 0.5 wt. % of acetic acid, based on the total weight of the ATH particles in the slurry, was added to the slurry. The slurry was stirred for 20 minutes at room temperature to obtain a uniform liquid. A pilot spray drier from the Niro company, type “Minor Production”, was used to spray dry the slurry. The throughput of the spray drier was approx. 12 kg/h solids, the inlet air temperature was about 400° C., and the outlet air temperature was about 130° C. The median pore size r₅₀ and the maximum specific pore volume Vₘₐₓ of the dried aluminum hydroxide powder was derived from mercury porosimetry. As can be seen in Table 1, both the r₅₀ and the Vₘₐₓ of the ATH particles produced in this example were lower than the r₅₀ and Vₘₐₓ of the ATH particles produced in Example 1.

### Example 3

### According to the Invention

A filter cake with an ATH solid content of 56 wt. % was prepared by precipitation and filtration. The ATH particles in the filter cake had a median particle size d₅₀ of 1.87 μm and a specific BET surface of 3.4 m²/g. A sufficient amount of water was added to the filter cake to obtain a slurry with a solid content of 33 wt. %. A quantity of 1.5 wt. % of acetic acid, based on the total weight of the ATH particles in the slurry, was added to the slurry. The slurry was stirred for 20 minutes at room temperature to obtain a uniform liquid. A pilot spray drier from the Niro company, type “Minor Production”, was used to spray dry the slurry. The throughput of the spray drier was approx. 12 kg/h solids, the inlet air temperature was about 400° C., and the outlet air temperature was about 130° C. The median pore size r₅₀ and the maximum specific pore volume Vₘₐₓ of the dried aluminum hydroxide powder was derived from mercury porosimetry. As can be seen in Table 1, both the r₅₀ and the Vₘₐₓ of the ATH particles produced in this example were lower than the r₅₀ and Vₘₐₓ of the ATH particles produced in Example 1.

TABLE 1

| | Example 1 | Example 2 | Example 3 |
|---|---|---|---|
| | (Comp.) | (Inventive) | (Inventive) |
| Amount of acetic acid (wt. %) | 0 | 0.5 | 1.5 |
| Median pore size r₅₀ (μm) | 0.42 | 0.40 | 0.33 |
| Max. spec. pore volume | 529 | 498 | 447 |
| Vmax (mm³/g) | | | |

What is claimed:

1) A process comprising:
a) adding to a filter cake containing in the range of from about 1 to about 80 wt. % ATH particles, based on the total weight of the filter cake, in the range of from about 0.1 to about 10 wt. %, based on the total weight of the ATH particles in the filter cake, of one or more organic acids, and optionally i) one or more dispersing agents; ii) water; or combinations of i) and ii), thereby producing an acid-containing ATH slurry, and
b) drying said acid-containing ATH slurry thereby producing ATH product particles.

2) The process according to claim 1 wherein said ATH product particles have an oil absorption, as determined by ISO 787-5:1980 of in the range of from about 1 to about 35%, a BET specific surface area, as determined by DIN-66132, in the range of from about 1 to 15 m²/g, and a d₅₀ in the range of from about 0.5 to 2.5 μm.

3) The process according to claim 2 wherein said ATH product particles have a Vₘₐₓ in the range of from about 300 to about 700 mm³/g and/or an r₅₀ in the range of from about 0.09 to about 0.33 μm.

4) The process according to claim 1 wherein said filter moist cake is obtained from a process that comprises dissolving aluminum hydroxide in caustic soda to form a sodium aluminate liquor; filtering the sodium aluminate solution to remove impurities; cooling and diluting the sodium aluminate liquor to an appropriate temperature and concentration; adding ATH seed particles to the sodium aluminate solution; allowing ATH particles to precipitate from the solution thus forming an ATH suspension containing in the range of from about 80 to about 160 g/l ATH, based on the suspension; filtering the ATH suspension thus forming a filter cake; optionally washing said filter cake one or more times with water.

5) The process according to claim 1 wherein the BET of the ATH particles in the filter cake is a) in the range of from about 1.0 to about 4.0 m²/g or b) in the range of from about 4.0 to about 8.0 m²/g, or c) in the range of from about 8.0 to about 14 m²/g.

6) The process according to claim 5 wherein the ATH particles in the filter cake have a d₅₀ in the range of from about 1.5 to about 3.5 μm.

7) The process according to claim 6 wherein said filter cake contains i) in the range of from about 25 to about 70 wt. % ATH particles; ii) in the range of from about 55 to about 65 wt. % ATH particles; iii) in the range of from about 40 to about 60 wt. % ATH particles; iv) in the range of from about 45 to about 55 wt. % ATH particles; v) in the range of from about 25 to about 50 wt. % ATH particles; or vi) in the range of from about 30 to about 45 wt. % ATH particles; wherein all wt. % are based on the total weight of the filter cake.

8) The process according to claim 1 wherein the ATH product particles have:
a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, and a Vₘₐₓ in the range of from about 390 to about 480 mm³/g; or
b) a BET in the range of from about 6 to about 9 m²/g, a d₅₀ in the range of from about 1.3 to about 2.0 μm, an oil absorption in the range of from about 25 to about 40%, an r₅₀ in the range of from about 0.185 to about 0.325 μm, and a Vₘₐₓ in the range of from about 400 to about 600 mm³/g; or
c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, and a Vₘₐₓ in the range of from about 300 to about 700 mm³/g.

9) The process according to claim 1 wherein said one or more organic acids is added under mechanical agitation.

10) The process according to claim 1 wherein said one or more organic acids is selected from fumic acid, acetic acid, citric acid, and the like.

11) The process according to claim 1 wherein the drying of said organic acid-containing slurry is achieved through the use of filter drying, spray drying, mill-drying, and the like.

12) The process according to claim 1 wherein said one or more organic acids is acetic acid.

13) The process according to claim 1 wherein i) an organic acid; ii) an organic acid and a dispersing agent; iii) an organic acid and water; or iv) an organic acid, water, and a dispersing agent is used to produce the acid-containing ATH slurry.

14) A flame retarded polymer formulation comprising at least one synthetic resin and in the range of from about 5 wt % to about 90 wt %, based on the weight of the flame retarded polymer formulation of mill-dried ATH particles produced according to claim 1.

15) A flame retarded polymer formulation comprising at least one synthetic resin and in the range of from about 5 wt % to about 90 wt %, based on the weight of the flame retarded polymer formulation of mill-dried ATH particles produced according to claim 8.

16) A molded or extruded article made from the flame retarded polymer formulation according to claim 14.

17) A molded or extruded article made from the flame retarded polymer formulation according to claim 15.

18) A process comprising drying an ATH slurry containing one or more acid(s) and ATH particles thereby producing ATH product particles.

19) The process according to claim 18 wherein said slurry contains in the range of from about 1 to about 80 wt. %, based on the total weight of the slurry, ATH particles.

20) The process according to claim 18 wherein said slurry contains in the range of from about 1 to about 40 wt. %, based on the total weight of the slurry, ATH particles.

21) The process according to claim 18 wherein said slurry is obtained by adding to a filter cake containing in the range of from about 1 to about 80 wt. % ATH particles, based on the total weight of the filter cake, in the range of from about 0.1 to about 10 wt. %, based on the total weight of the ATH particles in the filter cake, of one or more organic acids, and optionally i) one or more dispersing agents; ii) water; or combinations of i) and ii), thereby producing an acid-containing ATH slurry.

22) The process according to claim 18 wherein said one or more acid(s) is one or more organic acid(s).

23) The process according to claim 22 wherein said one or more organic acid(s) is selected from fumic acid, acetic acid, citric acid, and the like.

24) The process according to claim 18 wherein i) an organic acid; ii) an organic acid and a dispersing agent; iii) an organic acid and water; or iv) an organic acid, water, and a dispersing agent is used to produce the acid-containing ATH slurry.
